(19) United States
(12) Patent Application Publication
(10) Pub. No.: US 2025/0357692 A1
(43) Pub. Date: Nov. 20, 2025

(54) TERMINAL DEVICE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Xingke YANG, Mie (JP)

(21) Appl. No.: 18/873,334

(22) PCT Filed: May 23, 2023
(86) PCT No.: PCT/JP2023/019055

§ 371 Date: Dec. 10, 2024

(30) Foreign Application Priority Data
Jun. 13, 2022 (JP) 2022-094896

(51) Int. Cl. H01R 13/11; H01R 13/42

(52) U.S. Cl. CPC H01R 13/11; H01R 13/42

(57) ABSTRACT

Provided is a terminal device with which it is possible to simplify a connection structure and the work of connecting wires. A connector (10), serving as this terminal device, comprises: a first piece (42, 42A, 42B) and a second piece (43, 43A, 43B) which are formed of a conductive plate and which are integrally connected so as to be openable via a folded-back section (41, 41A, 41B); and a retaining part (27, 27A, 27B) that maintains the closed state of the first piece (42, 42A, 42B) and the second piece (43, 43A, 43B) in which the same are closed so as to sandwich a wire (90) therebetween.

### TECHNICAL FIELD

The present disclosure relates to a terminal device.

### BACKGROUND

Patent Document 1 discloses a connector as a terminal device provided with a housing, a board and a spring member. The board and the spring member are accommodated into the housing. A wire is inserted between the board and the spring member. The wire is connected to the board. The spring member presses the wire toward the board and ensures a contact state of the wire and the board by a biasing force thereof.

Patent Document 2 discloses a connector as a terminal device provided with a connector terminal and a housing. The connector terminal includes a wire connecting portion to be connected to a wire and a cover portion to be mounted on the wire connecting portion. The cover portion includes a pressing portion for sandwiching the wire between the wire connecting portion and the pressing portion in a state locked to the wire connecting portion.

### PRIOR ART DOCUMENT

### Patent Document

Patent Document 1: JP 2022-010651 A
Patent Document 2: JP 2019-079674 A

### SUMMARY OF THE INVENTION

### Problems to be Solved

In the case of Patent Document 1, since a contact load of the wire and the board depends on a biasing force of the spring member, there is a problem that it is difficult to stably maintain a connected state of the wire and the board.

In the case of Patent Document 2, in connecting the connector terminal and the wire, a crimping step is not necessary and there is a merit of being able to simplify a connecting operation. However, since the wire connecting portion and the cover portion are separated in the connector terminal, there is a concern for an increase of processing steps and the like and there is a room for further improvement.

Accordingly, the present disclosure aims to provide a terminal device capable of simplifying a connecting operation and a connection structure of a wire.

### Means to Solve the Problem

The present disclosure is directed to a terminal device with a first piece portion and a second piece portion formed of an electrically conductive plate material, the first and second piece portions being integrally coupled to be openable and closable via a folded portion, and a holding portion for maintaining a closed state of the first and second piece portions closed with a wire sandwiched therebetween.

### Effect of the Invention

According to the present disclosure, it is possible to provide a terminal device capable of simplifying a connecting operation and a connection structure of a wire.

### BRIEF DESCRIPTION OF THE DRAWINGS

FIG. 1 is a section of a connector as a terminal device in a first embodiment of the present disclosure.

FIG. 2 is an exploded perspective view showing a cover and a housing body in the first embodiment of the present disclosure.

FIG. 3 is a perspective view showing a terminal fitting in the first embodiment of the present disclosure.

FIG. 4 is an exploded perspective view showing the terminal fitting in an open state and a wire in the first embodiment of the present disclosure.

FIG. 5 is a perspective view showing a terminal fitting in a second embodiment of the present disclosure.

FIG. 6 is a perspective view showing the terminal fitting from an angle different from that in FIG. 5 in the second embodiment of the present disclosure.

FIG. 7 is a section showing a connector as a terminal device in the second embodiment of the present disclosure.

FIG. 8 is a perspective view showing a terminal fitting in a third embodiment of the present disclosure.

FIG. 9 is a perspective view showing the terminal fitting from an angle different from that in FIG. 8 in the third embodiment of the present disclosure.

FIG. 10 is a section showing a connector as a terminal device in the third embodiment of the present disclosure.

FIG. 11 is a section showing a contact state of a contact portion and a tab in the third embodiment of the present disclosure.

### DETAILED DESCRIPTION TO EXECUTE THE INVENTION

### Description of Embodiments of Present Disclosure

First, embodiments of the present disclosure are listed and described.

(1) The terminal device of the present disclosure is provided with a first piece portion and a second piece portion formed of an electrically conductive plate material, the first and second piece portions being integrally coupled to be openable and closable via a folded portion, and a holding portion for maintaining a closed state of the first and second piece portions closed with a wire sandwiched therebetween.

Since the above configuration does not require a crimping step in connecting the first and second piece portions to the wire, a connecting operation can be simplified. Moreover, since the first and second piece portions are integrated via the folded portion, a connection structure to the wire can also be simplified.

(2) Preferably, the first piece portion includes a first bent portion bent into a concave shape with respect to the second piece portion when viewed in a direction intersecting a length direction of the wire, the second piece portion includes a second bent portion bent into a convex shape with respect to the first piece portion when viewed in a direction intersecting the length direction of the wire, and the first and second bent portions are formed to fit each other with the wire sandwiched therebetween.

In the above configuration, the wire can be bent in a concave-convex manner and arranged between the first and second bent portions. Thus, the wire can be properly avoided from coming out from between the first and second bent portions.

(3) A terminal fitting may include the folded portion, the first piece portion and the second piece portion, the terminal fitting may be shaped to extend from a front end to a rear end in a front-rear direction, the front-rear direction being the length direction of the wire, the folded portion may be formed on the front end of the terminal fitting, and the terminal fitting may include a resiliently deformable contact portion for contacting a mating terminal fitting in a front end part including the front end and a wire fixing portion for sandwiching the wire between rear end parts of the first and second piece portions in a rear end part including the rear end.

In the above configuration, the entire terminal fitting can be simply shaped by folding the first and second piece portions via the folded portion. Particularly, since the wire fixing portion is open rearward in the above configuration, the wire can be easily arranged inside the wire fixing portion.

(4) A terminal fitting may include the folded portion, the first piece portion and the second piece portion, the terminal fitting may be shaped to extend from a front end to a rear end in a front-rear direction, the front-rear direction being the length direction of the wire, the folded portion may be formed on the rear end of the terminal fitting, the terminal fitting may include a resiliently deformable contact portion for contacting a mating terminal fitting in a front end part including the front end and a wire fixing portion for sandwiching the wire between rear end parts of the first and second piece portions in a rear end part including the rear end, and the wire fixing portion may include a wire insertion hole penetrating through the folded portion, the wire being inserted through the wire insertion hole.

In the above configuration, the entire terminal fitting can be simply shaped by folding the first and second piece portions via the folded portion. The wire can be arranged inside the wire fixing portion through the wire insertion hole. Particularly, a degree of freedom in the shape of the contact portion can be enhanced.

Note that, in the case of the above configurations (3) and (4), the “front end part” is a part in front of the wire fixing portion and the “rear end part” is a part behind the contact portion.

(5) A terminal fitting may include the folded portion, the first piece portion and the second piece portion, the terminal device may further include a housing for accommodating the terminal fitting, the housing may have a support surface for supporting the terminal fitting, and the holding portion may be shaped to sandwich the first and second piece portions between the support surface and the holding portion at a position facing the support surface in the housing.

In the above configuration, the closed state of the first and second piece portions can be maintained by forming the holding portion shaped to sandwich the first and second piece portions at the position facing the support surface, wherefore the structure of the holding portion can be simplified.

(6) A terminal fitting may include the folded portion, the first piece portion and the second piece portion, the terminal device may further include a housing for accommodating the terminal fitting, the housing may have a support surface for supporting the terminal fitting, and the holding portion may be formed into a convex shape arranged inside the second bent portion of the second piece portion to sandwich the first and second piece portions between the support surface and the holding portion at a position facing the support surface in the housing.

In the above configuration, a bent shape of the second bent portion can be held by the holding portion having the convex shape and arranged inside the second bent portion.

(7) A terminal fitting may include the folded portion, the first piece portion and the second piece portion, the terminal device may further include a housing for accommodating the terminal fitting, the housing may have a support surface for supporting the terminal fitting, the holding portion may be shaped to sandwich the first and second piece portions between the support surface and the holding portion at a position facing the support surface in the housing, and the support surface may have a recess, the first bent portion of the first piece portion being fit into the recess.

In the above configuration, a positional deviation of the terminal fitting with respect to the housing can be restricted by the first bent portion fit in the recess of the support surface.

### Details of Embodiment of Present Disclosure

A specific example of the present disclosure is described below with reference to the drawings. Note that the present invention is not limited to this illustration, but is represented by claims and intended to include all changes in the scope of claims and in the meaning and scope of equivalents.

### First Embodiment

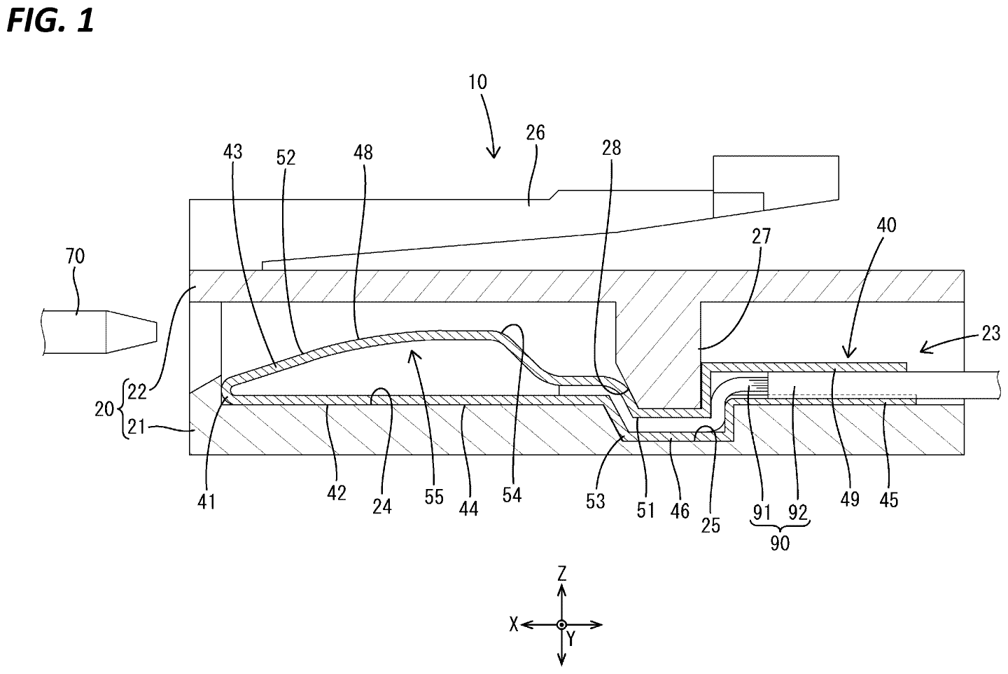

A connector 10 as a terminal device is illustrated in a first embodiment of the present disclosure. As shown in FIG. 1, the connector 10 is provided with a housing 20 and terminal fittings 40. The terminal fitting 40 is electrically and mechanically connected to an end part of a wire 90. Note that, in the following description, left and right sides of FIG. 1 are referred to as front and rear sides concerning a front-rear direction. A tip side of an end part of the wire 90 is the front side. A vertical direction is based on a vertical direction of FIG. 1. A lateral direction is based on a direction orthogonal to the plane of FIG. 1. In FIGS. 1 to 4, the front-rear direction, the lateral direction and the vertical direction are respectively represented by X, Y and Z. The vertical direction is not necessarily limited to a direction of gravity when the connector 10 is installed.

### (Housing)

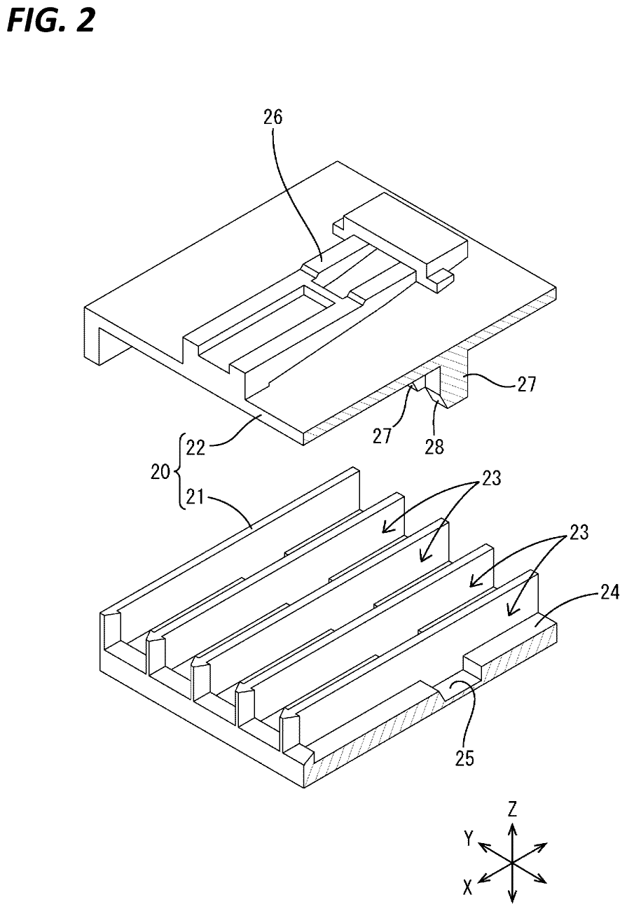

The housing 20 is made of synthetic resin, has a rectangular shape in a plan view and has a flat outer shape with a small vertical dimension. As shown in FIG. 2, the housing 20 is provided with a housing body 21 and a cover 22. The housing body 21 includes a plurality of cavities 23 arranged in the lateral direction. Each cavity 23 is in the form of a groove extending in the front-rear direction and open upward in the housing body 21. The bottom surface of each cavity 23 of the housing body 21 is configured as a support surface 24 for supporting the terminal fitting 40. The support surface 24 of each cavity 23 has a recess 25 dropped at a halfway position in the front-rear direction. The recess 25 has a concave shape in a side view and is formed over the entire width of the cavity 23.

The cover 22 is put on the housing body 21 from above and closes each cavity 23 from above. The cover 22 and the housing body 21 are locked to each other by unillustrated locking portions. A lock portion 26 projects on the upper surface of the cover 22. The lock portion 26 holds the housing 20 and an unillustrated mating housing in a connected state by locking the mating housing. Further, a plurality of holding portions 27 project on the lower surface of the cover 22. The respective holding portions 27 are formed individually for the respective cavities 23. Each holding portion 27 is in the form of a rectangular column and arranged to face the recess 25. Each holding portion 27 includes a chamfered slope portion 28 on a front lower corner part where the front end surface and the lower end surface intersect.

### (Terminal Fitting)

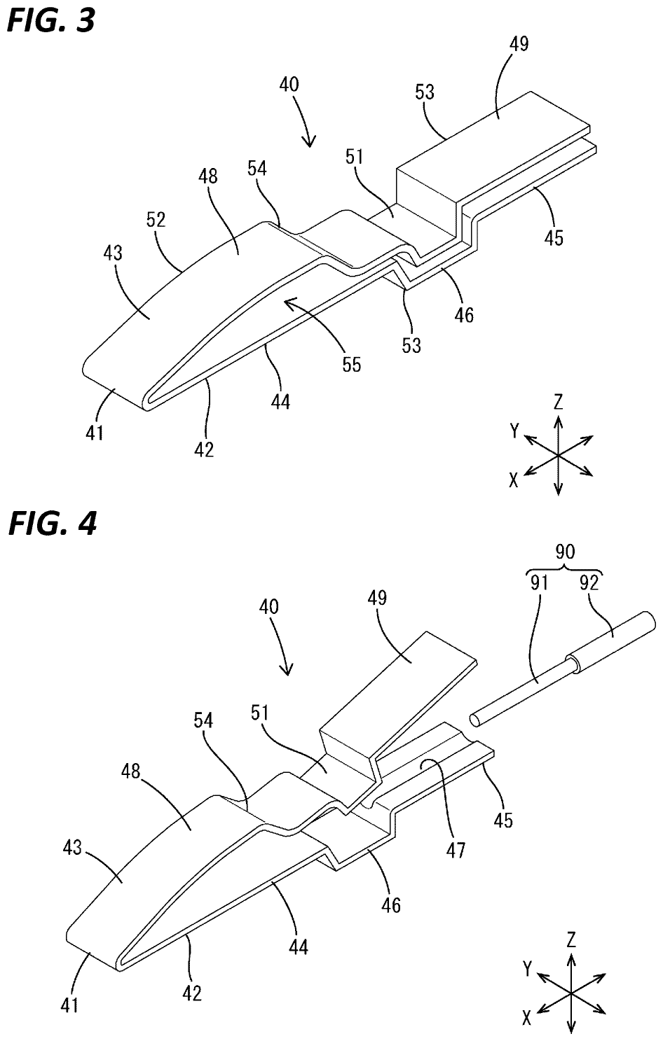

The terminal fitting 40 is formed by stamping one electrically conductive metal plate material and, then, bending a stamped-out piece. The terminal fitting 40 is in the form of a plate piece extending from a front end to a rear end and having a constant width in the lateral direction. Specifically, as shown in FIG. 3, the terminal fitting 40 is integrally configured by a folded portion 41 located on the front end and having a bent shape, a first piece portion 42 extending rearward from the lower end of the folded portion 41 and a second piece portion 43 extending rearward from the upper end of the folded portion 41.

The first and second piece portions 42, 43 are integrally coupled to be openable and closable with the folded portion 41 as a fulcrum so as to approach and separate from each other as shown in FIGS. 3 and 4. Note that the following description of the structure of the terminal fitting 40 is based on a case where the first and second piece portions 42, 43 are in a closed state (case shown in FIGS. 1 and 3) unless otherwise specified.

The first piece portion 42 is formed by a first front piece portion 44 arranged along the front-rear direction in a front end part including the folded portion 41, a first rear piece portion 45 arranged along the front-rear direction in a rear end part including the rear end as a free end, and a first bent portion 46 bent downward between the first front piece portion 44 and the first rear piece portion 45 and having a concave shape in a side view. As shown in FIG. 4, the first rear piece portion 45 includes a groove portion 47 in an upper surface facing the second piece portion 43. The groove portion 47 extends over the entire length in the front-rear direction of the first rear piece portion 45 and has a curved cross-sectional shape in a lateral central part of the upper surface of the first rear piece portion 45.

The first bent portion 46 is formed by a bottom surface part arranged along the front-rear direction, a front surface part inclined obliquely to a front upper side from the front end of the bottom surface part to the rear end of the first front piece portion 44 and a rear surface part rising in the vertical direction from the rear end of the bottom surface part to the front end of the first rear piece portion 45. Note that the recess 25 of the housing 20 is also formed with a bottom surface part, a front surface part and a rear surface part shaped to correspond to the first bent portion 46.

The second piece portion 43 is formed by a second front piece portion 48 bulging into a chevron shape in a side view in a front end part including the folded portion 41, a second rear piece portion 49 arranged along the front-rear direction in a rear end part including the rear end as a free end, and a second bent portion 51 bent downward between the second front piece portion 48 and the second rear piece portion 49 and having a concave shape in a side view.

The second bent portion 51 is shaped to correspond to the first bent portion 46. The second bent portion 51 is convexly bent with respect to the first piece portion 42 to approach the first piece portion 42 in a side view. On the other hand, the first bent portion 46 is concavely bent with respect to the second piece portion 43 to be separated from the second piece portion 43 in a side view. As shown in FIG. 1, the first and second bent portions 46, 51 are fit to each other while sandwiching a conductor 91 of the wire 90.

As shown in FIGS. 1 and 4, a coated wire in which the outer periphery of a single core wire as the conductor 91 is surrounded by an insulating coating 92 is illustrated as the wire 90. The conductor 91 is exposed in an end part (tip part, front end part) of the wire 90 by removing the coating 92.

As shown in FIG. 1, the second bent portion 51 and the second rear piece portion 49 are respectively arranged to face in parallel to the first bent portion 46 and the second rear piece portion 49 via a clearance for holding the end part of the wire 90 between the first bent portion 46, the first rear piece portion 45 and the second bent portion 51, the second rear piece portion 49. Here, the first rear piece portion 45, the first bent portion 46, the second rear piece portion 49 and the second bent portion 51 are configured as a wire fixing portion 53 for fixing the wire 90 by receiving a holding force of the holding portion 27. Specifically, the wire fixing portion 53 holds the conductor 91 exposed in the end part of the wire 90 (hereinafter, merely referred to as the “conductor 91 of the wire 90”) between the first bent portion 46 and the second bent portion 51, and holds the coating 92 in the end part of the wire 90 (hereinafter, merely referred to as the “coating 92 of the wire 90”) between the first rear piece portion 45 and the second rear piece portion 49.

The second front piece portion 48 is formed by a part including a top 54 on a rear end side and gently inclined in a curved manner from the folded portion 41 to the top 54, a part steeply inclined downward from the top 54 and a part facing in parallel to the first front piece portion 44.

A front end part of the terminal fitting 40 is configured as a resiliently deformable contact portion 52. The contact portion 52 has a deflection space 55 open in the lateral direction among the folded portion 41, the first front piece portion 44 and the second front piece portion 48. The deflection space 55 serves as a space for allowing a deflecting movement of the second front piece portion 48.

### (Assembly Method and Functions)

In assembling, the housing body 21 is first chucked and positioned.

Subsequently, the terminal fitting 40 is inserted into the cavity 23 of the housing body 21 from above. Then, the first front piece portion 44 and the first rear piece portion 45 are arranged along the support surface 24 of the housing body 21 and the terminal fitting 40 is placed on the support surface 24. Further, the first bent portion 46 is fit into the recess 25 of the housing body 21, and the terminal fitting 40 is positioned with respect to the housing body 21.

The terminal fitting 40 is set in an open state in the housing body 21, and a space between the rear ends of the first and second piece portions 42, 43 is expanded rearward (see FIG. 4). In this state, the wire 90 is inserted between the first and second piece portions 42, 43 through the space between the rear ends from behind. The wire 90 is arranged between the first and second piece portions 42, 43 while being positioned along the groove portion 47 of the first rear piece portion 45. The conductor 91 of the wire 90 is arranged from a space between the first and second bent portions 46, 51 to the first front piece portion 44 and the second rear piece portion 49. The coating 92 of the wire 90 is arranged between the first rear piece portion 45 and the second rear piece portion 49 while being supported in the groove portion 47. An inserting operation of the wire 90 can be performed by an automatic machine.

Subsequently, the cover 22 is mounted on the housing body 21 from above. In the process of mounting the cover 22, the respective holding portions 27 are fit into the second bent portions 51 of the respective terminal fittings 40 at once. Then, the bottom surface part of the second bent portion 51 of the terminal fitting 40 is pressed by the holding portion 27, and the second piece portion 43 tilts toward the first piece portion 42 with the folded portion 41 as a fulcrum. That is, the terminal fitting 40 is displaced into the closed state.

If the cover 22 is locked to and properly mounted on the housing body 21, the terminal fitting 40 reaches the closed state and a state of the holding portion 27 pressing the second bent portion 51 is maintained as shown in FIG. 1. The conductor 91 of the wire 90 is buckled along the bent shape between the first and second bent portions 46, 51, and bent in a concave-convex manner and firmly held between the first and second piece portions 42, 43. The first and second piece portions 42, 43 are sandwiched and held between the bottom surface part of the recess 25 of the housing body 21 and the holding portion 27 of the cover 22. In this way, the closed state of the terminal fitting 40 is maintained. Further, the holding portion 27 is arranged inside the second bent portion 51 and faces the front surface part of the second bent portion 51 and the first bent portion 46 is arranged inside the recess 25 and faces the front surface part of the recess 25, whereby the terminal fitting 40 is reliably restricted from coming out from the cavity 23. Note that, if the terminal fitting 40 is not inserted to a proper position in the cavity 23, the terminal fitting 40 can be moved forward to the proper position by the slope portion 28 of the holding portion 27 pressing the front surface part of the second bent portion 51.

Thereafter, the unillustrated mating housing is connected to the housing 20, and tabs 70 of mating terminal fittings are inserted into the cavities 23 of the housing 20 from front. The tab 70 slides on an inclined part on a front side of the second front piece portion 48, whereby the contact portion 52 can be resiliently displaced toward the deflection space 55. If the housing 20 is properly connected to the mating housing, the tabs 70 contact the tops 54 of the second front piece portions 48 and the terminal fittings 40 and the mating terminal fittings are properly connected.

As described above, according to this embodiment, since the closed state of the terminal fitting 40 is maintained with the wire 90 sandwiched between the first and second piece portions 42, 43, a crimping step is not required and a connecting operation can be simplified in connecting the terminal fitting 40 and the wire 90. Moreover, since the first and second piece portions 42, 43 are integrated via the folded portion 41, a connection structure to the wire 90 can also be simplified.

Further, since the wire 90 is bent and held in a concave-convex manner between the first and second bent portions 46, 51 when the terminal fitting 40 is in the closed state, the wire 90 can be properly avoided from coming out from the space between the first and second bent portions 46, 51.

Further, the first and second piece portions 42, 43 are folded via the folded portion 41, whereby the entire terminal fitting 40 can be easily shaped. Particularly, since the wire fixing portion 53 is open rearward between the rear ends of the first and second piece portions 42, 43 in the first embodiment, the wire 90 can be easily arranged inside the wire fixing portion 53.

Further, as the cover 22 is mounted on the housing body 21, the respective holding portions 27 press the first piece portions 42 of the respective terminal fittings 40 at once and the respective terminal fittings 40 are maintained in the closed state. Thus, the structure of each holding portion 27 can be simplified.

Further, since the first bent portion 46 is fit into the recess 25 when the terminal fitting 40 is placed on the support surface 24 of the housing body 21, a positional deviation of the terminal fitting 40 with respect to the housing 20 can be restricted.

Further, since the holding portion 27 is fit into the second bent portion 51 if the cover 22 is mounted on the housing body 21, the positional deviation of the terminal fitting 40 with respect to the housing 20 can be reliably restricted. Further, the bent shape of the second bent portion 51 is reinforced by the holding portion 27.

### Second Embodiment

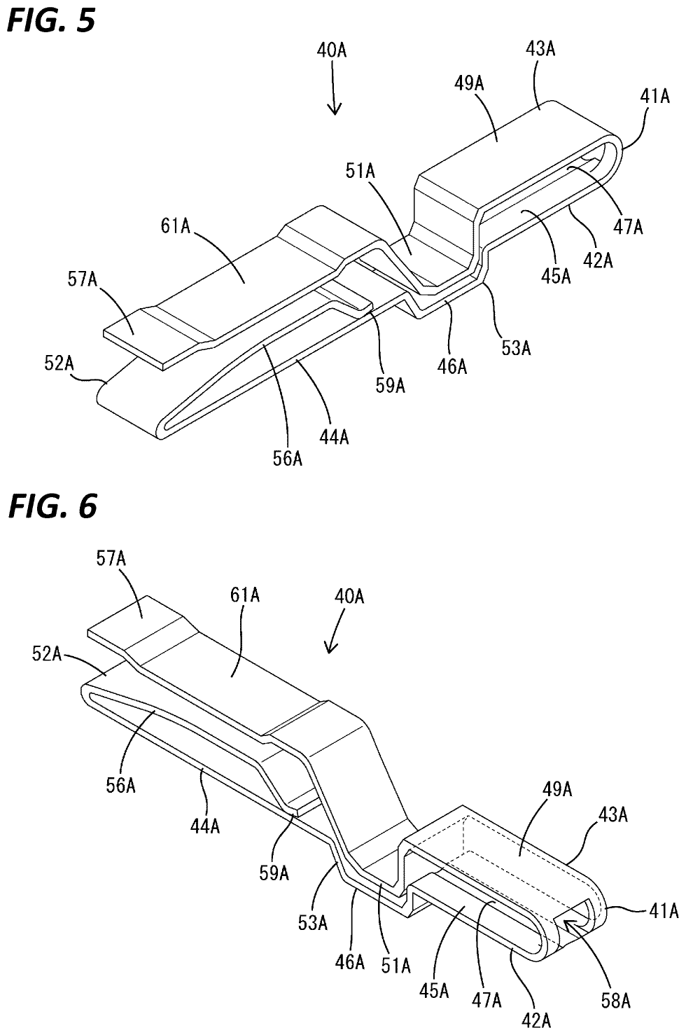

A terminal fitting 40A of a second embodiment of the present disclosure is integrally formed, such as by bending one electrically conductive metal plate material, similarly to the terminal fitting 40 of the first embodiment and, as shown in FIGS. 5 and 6, includes a folded portion 41A and a first piece portion 42A and a second piece portion 43A coupled to be openable and closable via the folded portion 41A. Further, the terminal fitting 40A includes a contact portion 52A in a front end part including a front end, a wire fixing portion 53A in a rear end part including a rear end, and a first bent portion 46A and a second bent portion 51A in a front part of the wire fixing portion 53A similarly to the terminal fitting 40 of the first embodiment.

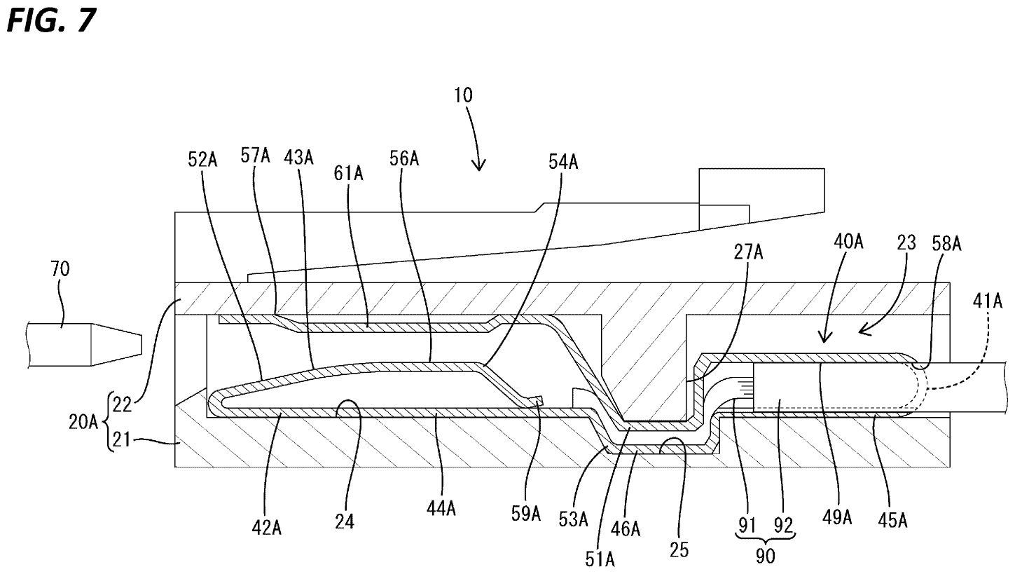

On the other hand, the terminal fitting 40A includes the folded portion 41A on the rear end of the wire fixing portion 53A, and includes a resilient portion 56A and a guide portion 57A in the contact portion 52A. In this point, the terminal fitting 40A differs from the terminal fitting 40 of the first embodiment. As shown in FIG. 7, a housing 20A is similar to the housing 20 of the first embodiment.

The folded portion 41A has a curved shape. First and second rear piece portions 45A, 49A respectively extend rearward from the lower and upper ends of the folded portion 41A and are arranged in parallel to each other. The first rear piece portion 45A includes a groove portion 47A in an upper surface. As shown in FIG. 6, the folded portion 41A includes a wire insertion hole 58A penetrating in the front-rear direction. The wire insertion hole 58A has a rectangular opening in the folded portion 41A in a back view. An opening width in the lateral direction of the wire insertion hole 58A corresponds to an outer diameter of a wire 90.

The contact portion 52A includes a first front piece portion 44A extending along the front-rear direction. The resilient portion 56A is folded from the front end of the first front piece portion 44A and protrudes into a chevron shape in a side view. As shown in FIG. 7, the resilient portion 56A includes a top 54A on a rear end side, extends obliquely to a lower rear side from the top 54A and includes a free end part 59A for contacting along the first front piece portion 44A in a lower end part in an extension direction. The resilient portion 56A is shaped similarly to the second front piece portion 48 of the first embodiment except at the free end part 59A. The first bent portion 46A is formed into a shape similar to the first bent portion 46 of the first embodiment between the rear end of the first front piece portion 44A and the front end of the first rear piece portion 45A.

The guide portion 57A is in the form of a strip extending in the front-rear direction and arranged to face the resilient portion 56A above the resilient portion 56A. The guide portion 57A includes a receiving portion 61A dropped downward at a halfway position in the front-rear direction. The receiving portion 61A is arranged to extend along the front-rear direction. The second bent portion 51A is formed to have a shape similar to the second bent portion 51 of the first embodiment between the rear end of the guide portion 57A and the front end of the second rear piece portion 49A.

In assembling the wire 90, the wire 90 is inserted into the wire fixing portion 53A from behind through the wire insertion hole 58A with the first and second piece portions 42A, 43A opened via the folded portion 41A. The wire 90 is inserted in a positioned state into the wire insertion hole 58A. A conductor 91 of the wire 90 can reach the first front piece portion 44A from the first rear piece portion 45A via the first bent portion 46A. Thereafter, the terminal fitting 40A reaches a closed state, whereby the conductor 91 of the wire 90 is held in a bent state between the first and second bent portions 46A, 51A. The second bent portion 51A is pressed toward a support surface 24A by a holding portion 27A, whereby the closed state of the terminal fitting 40A is maintained and the wire 90 is reliably held in the wire fixing portion 53A. This point is similar to the first embodiment.

When the housing 20A is connected to a mating housing, a tab 70 of a mating terminal fitting is inserted between the guide portion 57A and the resilient portion 56A. The resilient portion 56A is resiliently deformed while the free end part 59A is retracted along the first front piece portion 44A, and brings the tab 70 into contact with the top 54A. The tab 70 can maintain an insertion posture along the front-rear direction by applying a resilient restoring force receiving from the resilient portion 56A to the receiving portion 61A.

According to the second embodiment, the tab 70 of the mating terminal fitting is smoothly inserted into the inside of the contact portion 52A and stably held between the receiving portion 61A and the resilient portion 56A by being guided by the guide portion 57A. As a result, the connection reliability of the terminal fitting 40A and the mating terminal fitting can be improved.

### Third Embodiment

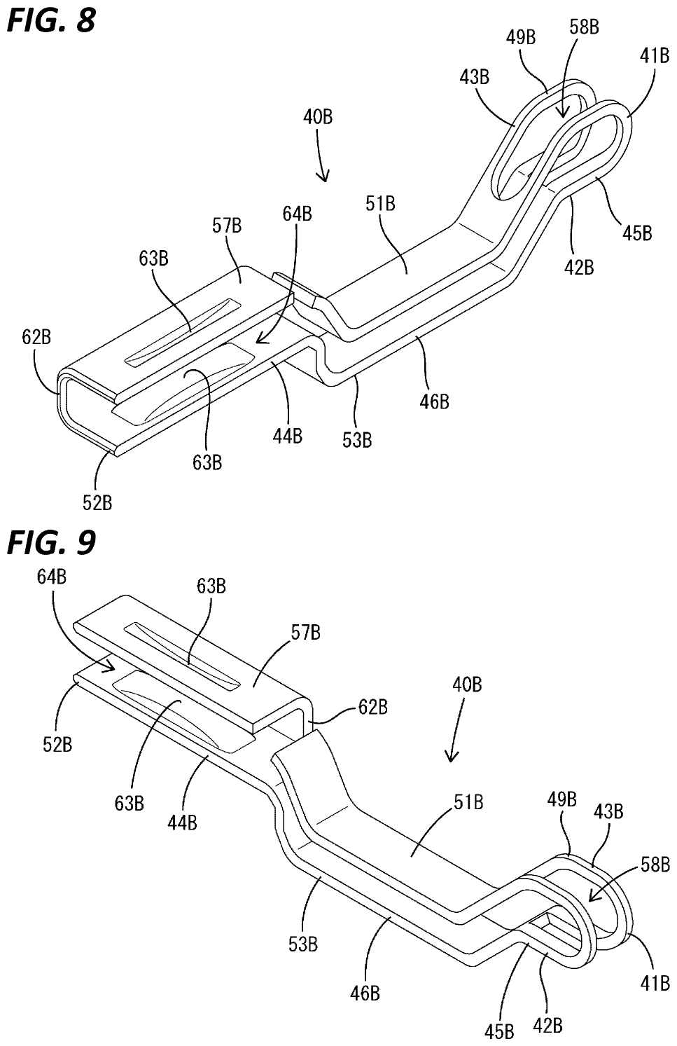

A terminal fitting 40B of a third embodiment of the present disclosure is integrally formed, such as by bending one electrically conductive metal plate material similarly to the terminal fitting 40 of the first embodiment and, as shown in FIGS. 8 and 9, includes a folded portion 41B and a first piece portion 42B and a second piece portion 43B coupled to be openable and closable via the folded portion 41B. Further, the terminal fitting 40B includes a contact portion 52B in a front end part including a front end, a wire fixing portion 53B in a rear end part including a rear end, and a first bent portion 46B and a second bent portion 51B in a front part of the wire fixing portion 53B similarly to the terminal fitting 40 of the first embodiment. Further, similarly to the terminal fitting 40A of the second embodiment, the terminal fitting 40B includes a folded portion 41B having a curved shape on the rear end of the wire fixing portion 53B.

The folded portion 41B has a larger radius of curvature than the folded portion 41A of the second embodiment. A wire insertion hole 58B is largely open from the folded portion 41B to first and second rear piece portions 45B, 49B.

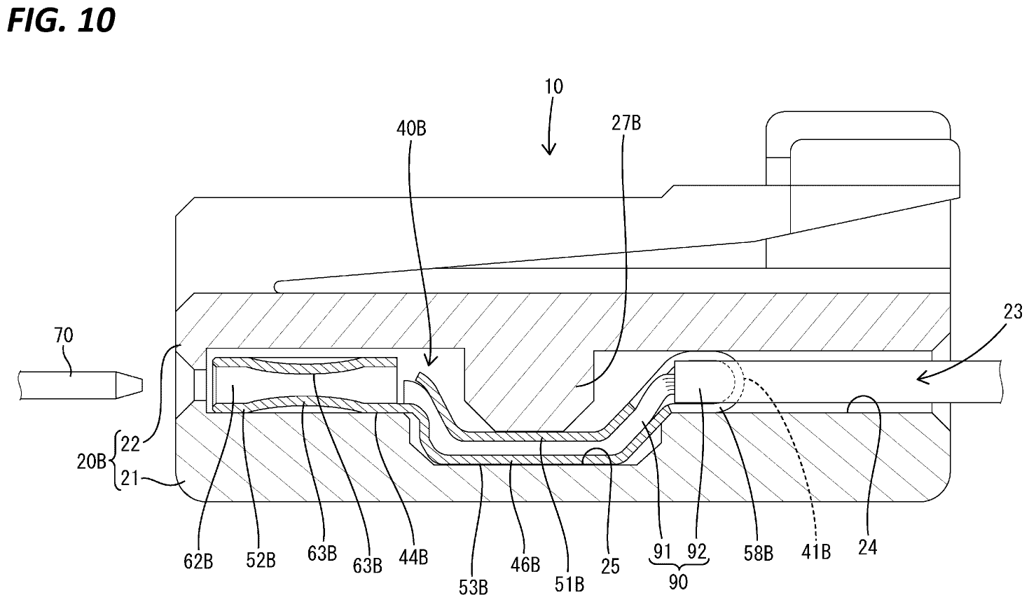

On the other hand, the contact portion 52B is formed by a first front piece portion 44B, a side portion 62B and a guide portion 57B in the terminal fitting 40B of the third embodiment. In this point, the terminal fitting 40B of the third embodiment differs from the terminal fittings 40, 40A of the first and second embodiments. As shown in FIG. 10, a housing 20B is similar to the housing 20 of the first embodiment and includes holding portions 27B for pressing the second bent portions 51B.

The first front piece portion 44B is in the form of a strip along the front-rear direction. The rear end of the first front piece portion 44B is coupled to the front end of the first bent portion 46B.

The guide portion 57B is also in the form of a strip along the front-rear direction and arranged to face the first front piece portion 44B above the first front piece portion 44B. The first front piece portion 44B and the guide portion 57B include a pair of bead portions 63B extending in the front-rear direction on facing surfaces of the both. The respective bead portions 63B are formed by press working in lateral central parts of the first front piece portion 44B and the guide portion 57B.

The side portion 62B extends between one end part in the lateral direction of the first front piece portion 44B and one end part in the lateral direction of the guide portion 57B. The side portion 62B is in the form of a wall along the vertical direction and has the same length in the front-rear direction as the first front piece portion 44B and the guide portion 57B. In the contact portion 52B, the other end side in the lateral direction facing the side portion 62B is open as an open portion 64B.

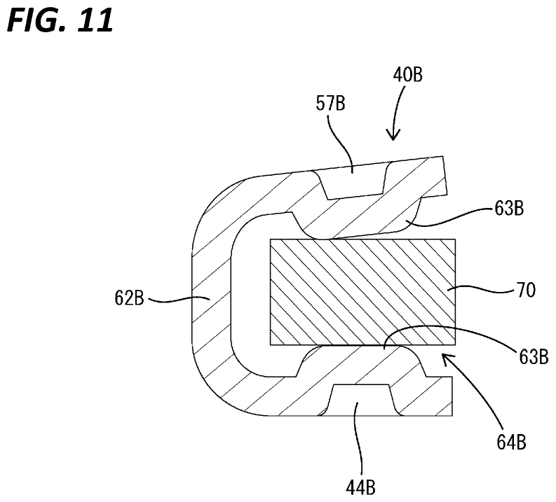

If the housing 20B is connected to a mating housing, a tab 70 of a mating terminal fitting is inserted between the guide portion 57B and the first front piece portion 44B. As shown in FIG. 11, the tab 70 contacts the respective bead portions 63B, whereby the open portion 64B is expanded in the vertical direction and the side portion 62B and the guide portion 57B are resiliently deformed outward. Here, since receiving resilient reaction forces of the side portion 62B and the guide portion 57B, the tab 70 can contact the bead portions 63B with a proper contact load.

### Other Embodiments of Present Disclosure

The embodiments disclosed this time should be considered illustrative in all aspects, rather than restrictive, and the following other embodiments are also included in the present disclosure.

The wire fixing portion may have a locking shape such as a biting projection or emboss processing on a surface facing the coating of the wire. According to this, the wire is more reliably prevented from coming out from the wire fixing portion.

Only the conductor of the wire may be arranged inside the wire fixing portion. In this case, in the second and third embodiments, only the conductor of the wire may be inserted through the wire insertion hole and the opening width in the lateral direction of the wire insertion hole can be reduced. As a result, the strength of the folded portion is easily ensured.

The housing may not include the cover and a retainer may be mounted into the housing body. In this case, the holding portions may be formed on the retainer.

The holding portions may not be formed on the housing and may be configured as a binding member such as a tie band, a tape or a shrinkage tube.

The holding portion may not be formed on the housing and may be provided in the terminal fitting in the form of a locking portion formed on the first piece portion and a locked portion formed on the second piece portion. In this case, the first and second piece portions are maintained in the closed state by locking the locking portion to the locked portion.

The conductor of the wire may be a stranded wire formed by twisting a plurality of strands.

The bead portion of the third embodiment may be formed only on either one of the first front piece portion and the guide portion.

### LIST OF REFERENCE NUMERALS

10 connector (terminal device)
20, 20A, 20B . . . housing
21 . . . housing body
22 . . . cover
23 . . . cavity
24, 24A . . . support surface
25 recess
26 . . . lock portion
27, 27A, 27B . . . holding portion
28 . . . slope portion
40, 40A, 40B . . . terminal fitting
41, 41A, 41B . . . folded portion
42, 42A, 42B . . . first piece portion
43, 43A, 43B . . . second piece portion
44, 44A, 44B . . . first front piece portion
45, 45A, 45B . . . first rear piece portion
46, 46A, 46B . . . first bent portion
47, 47A . . . groove portion
48 second front piece portion
49, 49A, 49B . . . second rear piece portion
51, 51A, 51B . . . second bent portion
52, 52A, 52B . . . contact portion
53, 53A, 53B . . . wire fixing portion
54, 54A . . . top
55 . . . deflection space
56A . . . resilient portion
57A, 57B . . . guide portion
58A, 58B . . . wire insertion hole
59A . . . free end part
61A . . . receiving portion
62B . . . side portion
63B . . . bead portion
64B . . . open portion
70 . . . tab
90 . . . wire
91 . . . conductor
92 . . . coating

1. A terminal device, comprising:
a first piece portion and a second piece portion formed of an electrically conductive plate material, the first and second piece portions being integrally coupled to be openable and closable via a folded portion; and
a holding portion for maintaining a closed state of the first and second piece portions closed with a wire sandwiched therebetween.

2. The terminal device of claim 1, wherein:
the first piece portion includes a first bent portion bent into a concave shape with respect to the second piece portion when viewed in a direction intersecting a length direction of the wire,
the second piece portion includes a second bent portion bent into a convex shape with respect to the first piece portion when viewed in a direction intersecting the length direction of the wire, and
the first and second bent portions are formed to fit each other with the wire sandwiched therebetween.

3. The terminal device of claim 1, wherein:
a terminal fitting includes the folded portion, the first piece portion and the second piece portion,
the terminal fitting is shaped to extend from a front end to a rear end in a front-rear direction, the front-rear direction being the length direction of the wire,
the folded portion is formed on the front end of the terminal fitting, and
the terminal fitting includes a resiliently deformable contact portion for contacting a mating terminal fitting in a front end part including the front end and a wire fixing portion for sandwiching the wire between rear end parts of the first and second piece portions in a rear end part including the rear end.

4. The terminal device of claim 1, wherein:
a terminal fitting includes the folded portion, the first piece portion and the second piece portion,
the terminal fitting is shaped to extend from a front end to a rear end in a front-rear direction, the front-rear direction being the length direction of the wire,
the folded portion is formed on the rear end of the terminal fitting,
the terminal fitting includes a resiliently deformable contact portion for contacting a mating terminal fitting in a front end part including the front end and a wire fixing portion for sandwiching the wire between rear end parts of the first and second piece portions in a rear end part including the rear end, and
the wire fixing portion includes a wire insertion hole penetrating through the folded portion, the wire being inserted through the wire insertion hole.

5. The terminal device of claim 1, wherein:
a terminal fitting includes the folded portion, the first piece portion and the second piece portion,
the terminal device further includes a housing for accommodating the terminal fitting,
the housing has a support surface for supporting the terminal fitting, and
the holding portion is shaped to sandwich the first and second piece portions between the support surface and the holding portion at a position facing the support surface in the housing.

6. The terminal device of claim 2, wherein:
a terminal fitting includes the folded portion, the first piece portion and the second piece portion,
the terminal device further includes a housing for accommodating the terminal fitting,
the housing has a support surface for supporting the terminal fitting, and
the holding portion is formed into a convex shape arranged inside the second bent portion of the second piece portion to sandwich the first and second piece portions between the support surface and the holding portion at a position facing the support surface in the housing.

7. The terminal device of claim 2, wherein:
a terminal fitting includes the folded portion, the first piece portion and the second piece portion,
the terminal device further includes a housing for accommodating the terminal fitting,
the housing has a support surface for supporting the terminal fitting,
the holding portion is shaped to sandwich the first and second piece portions between the support surface and the holding portion at a position facing the support surface in the housing, and
the support surface has a recess, the first bent portion of the first piece portion being fit into the recess.
